(19) United States
(12) Patent Application Publication
(10) Pub. No.: US 2004/0107571 A1
(43) Pub. Date: Jun. 10, 2004

(54) Arrangement for forming control windows in a cylinder wall

(76) Inventor: Martin Leiendecker, Weinstadt (DE)

Correspondence Address: Walter Ottesen, Patent Attorney, P.O. Box 4026, Gaithersburg, MD, 20885-4026, US

(21) Appl. No.: 10/724,041

(22) Filed: Dec. 1, 2003

(30) Foreign Application Priority Data
Nov. 30, 2002 (DE) 102 55 986.4

(51) Int. Cl. B23P 11/00

(52) U.S. Cl. 29/888.06

(57) ABSTRACT

An arrangement forms control windows (5) in a cylinder wall (2) of a cylinder housing (1) for a two-stroke internal combustion engine as openings of flow channels (4) in the interior space (3) of the cylinder delimited by the cylinder wall (2). The arrangement includes a driveable tool (7) which can be introduced at a free end (16) of a rotatable tool holder (17) into the interior space (3). The tool (7) can be brought into engagement with the cylinder wall (2) in the position in which the control window (5) is to be formed by transverse movement (13) with reference to a rotational axis (11) of the tool holder (17). A milling tool having a drive axis (19) is provided which lies essentially orthogonally to the rotational axis (11) of the tool holder (17) in order to provide a rapid and cost effective manufacture of a cylinder housing (1) with a precise manufacture of the control windows (5) in the cylinder wall (2).

### CROSS REFERENCE TO RELATED APPLICATION

This application claims priority of German patent application no. 102 55 986.4, filed Nov. 30, 2002, the entire contents of which is incorporated herein by reference.

### BACKGROUND OF THE INVENTION

In a cylinder housing, the cylinder wall delimits an interior space for accommodating a reciprocating piston and flow channels for ensuring a charge exchange in the combustion chamber are provided. The combustion chamber is delimited by the piston. In two-stroke internal combustion engines, the flow channels open into the interior space via respective control windows. The control window is sequentially covered and again cleared during operation of the engine in a manner known per se. In the manufacture of such a cylinder housing, a blank of the cylinder housing is first cast which is provided only with the flow channels enclosed in the cylinder wall. Such a blank cylinder body can be originally formed with a high efficiency and therefore at reduced manufacturing costs. In a second method step for manufacturing the cylinder, the control windows of each flow channel must be machined into the cylinder wall.

U.S. Pat. No. 6,041,499 discloses a contact-free machining forming method for cutting out the control window as an opening of the flow channel. Here, the tool for machining the cylinder wall is introduced into the interior space of the cylinder housing at a free end of a rotatable tool holder. The tool is brought into engagement with the cylinder wall at the position provided for the control window to be cut out via a transverse movement with respect to the rotational axis of the tool holder. The known method provides especially for an electric-discharge forming for configuring the control window and proceeds from the assumption that a precise machining in the formation of the control window in the cylinder wall should be possible with a contact-free forming method.

The machining of the cylinder housing with the known method requires, however, a demanding and expensive processing machine for the contact-free cutting out of the control window in the cylinder wall. With the manufacture of cylinders for small internal combustion engines as they are used, for example, in portable handheld work apparatus, the contact-free machining leads to high manufacturing costs of the cylinder and therefore of the engine, which, above all, is not tenable for the manufacture of high numbers of pieces.

### SUMMARY OF THE INVENTION

It is an object of the invention to provide an arrangement for forming control windows which is so improved that a rapid, cost effective manufacture of the cylinder housing is ensured with the greatest possible precise manufacturing of the control windows in the cylinder wall.

The arrangement of the invention is for forming a control window in a cylinder wall of a cylinder housing for a two-stroke internal combustion engine. The cylinder wall delimits an interior space of the cylinder and the control window is an opening of a flow channel into the interior space. The arrangement includes: a tool holder having a free end and defining a rotational axis about which the tool holder can be rotated; a driveable cutting tool mounted on the tool holder at the free end thereof and having a drive axis lying essentially orthogonally to the rotational axis; and, the tool holder with the driveable tool being movable into the interior space and being movable transversely with respect to the rotational axis so as to be brought into contact engagement with the cylinder wall at the position provided for the control window which is to be cut out of the cylinder wall.

The invention provides for a milling tool for forming the control window in the cylinder wall. This milling tool is mounted on the work tool holder with a drive axis lying essentially orthogonally to the rotational axis of the work tool holder. The milling tool of the invention can be introduced into the interior space of the cast cylinder housing with the work tool holder and can be brought into contact engagement with the cylinder wall for cutting out the control window via transverse movements of the tool holder. In accordance with the input of the milling operation to be undertaken, the milling tool can be guided at the cylinder wall with the work tool holder and ensures a high precision of the work operation when cutting out the control window. An angular configuration of the edge of the control window can be formed by a suitable adjustment of the rotational angle position of the work tool holder with little complexity.

The milling tool is advantageously configured as a front-milling tool and can therefore be brought into contact engagement in the cylinder wall via transverse movements of the tool holder and corresponding longitudinal movement of the milling tool in a direction along its drive axis. A breakthrough in the cylinder wall is machined out which is widened to the desired dimensions by suitably guiding the milling tool. Also, a two-stage machining can be advantageous. In the second machining step, the breakthrough, which was previously cut out with the front-milling tool, is widened with a peripheral-milling tool having a cutting action in the peripheral direction about the rotational axis of the milling tool. It is especially advantageous that the milling work tool of the invention is configured as an end-milling tool as well as a peripheral-milling tool or roller-milling tool in a manner of a dentist's tool. In this way, the configuration of a breakthrough and the subsequent widening of the breakthrough to the required dimensions is done with the same tool. In this way, and because of the shortening of the equipping times, a precise configuration of the control window is achieved in a short time and the configuration of the control window and therewith the manufacture of the cylinder takes place in a cost effective manner.

The milling tool of the invention, which is mounted orthogonally to the tool holder, is advantageously driven pneumatically or hydraulically whereby an independent drive of the milling tool is provided and a clear space for a space-saving construction of the orthogonal arrangement of the milling tool is made available at the tool holder. An electric-motoric drive is also practical. The milling tool is part of a tool head connectable to a tool case which, for example, has a pneumatic, hydraulic or electric motor for driving the milling tool. The tool head is attachable to the tool holder as a compact assembly with little complexity and can be utilized rapidly for machining cylinder housings.

In a preferred embodiment of the invention, the tool holder is part of a drive spindle of a controllable machine tool. The drive spindle of a numerically controlled machine tool can be precisely driven into any desired locations and angular positions within the interior space of the cylinder housing and the milling tool can be used effectively and precisely for cutting out the control window. With a suitable control of the rotational angular position of the work spindle, precise contours of the control windows as well as suitable alignments and angular positions of the wall sections at the end of the flow channels can be made and, in this way, the flow behavior of the fluid, which is to be guided through the flow channel into the combustion chamber, can be improved.

### BRIEF DESCRIPTION OF THE DRAWINGS

The invention will now be described with reference to the drawings wherein:

FIG. 1 is a perspective view of a cylinder housing;

FIG. 2 is a perspective plan view of a cylinder housing;

FIG. 3 is a cross section of a cylinder housing with a tool introduced into the interior space;

FIG. 4 is a plan view of the work tool head of the invention;

FIG. 5 is a longitudinal section view of a tool holder according to the invention; and,

FIGS. 6a to 6c show plan views of the tool head of the invention in different positions within the cylinder.

### DESCRIPTION OF THE PREFERRED EMBODIMENTS OF THE INVENTION

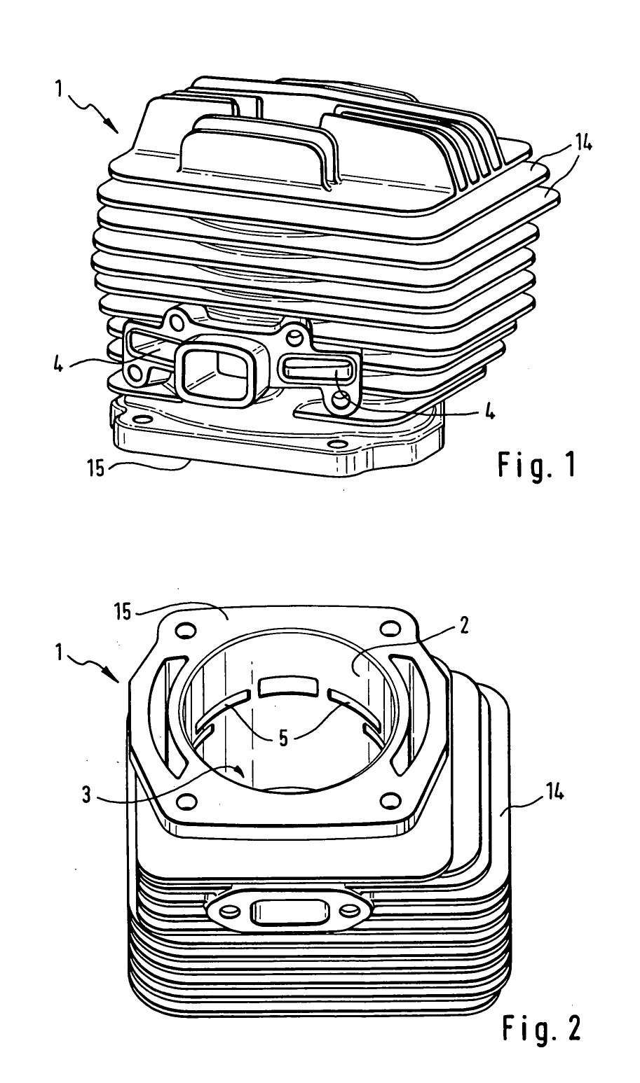

FIGS. 1 and 2 show a cylinder housing 1 for a two-stroke internal combustion engine which is used in a portable handheld work apparatus and is originally formed as a pressure-cast part. The cylinder housing 1 is equipped on its outer side with cooling ribs 14 for the air cooling of the cylinder. A cylinder wall 2 of the cylinder housing 1 delimits an interior space 3 for accommodating a reciprocating piston. The cylinder housing 1 is cast in an integral formation and is opened at one end for inserting the reciprocating piston (not shown). The open end is configured with a planar flange 15 for connecting to an engine block. Control windows 5 are machined into the cylinder wall 2 and these windows define openings of flow channels 4 into the interior space 3 of the cylinder and are opened and closed by the reciprocating piston for the purpose of exchanging charges during operation of the engine in a manner known per se. Depending upon the configuration of the engine, the flow channels 4 can supply air or can be fed with an air/fuel mixture from the crankcase of the engine or from a separate unit for mixture preparation.

In the manufacture of the cylinder housing 1, the cylinder housing is cast in a first processing step and, in a second processing step, the control windows 5 are cut out as the ends of the flow channels 4 by chip machining the cylinder wall. In this way, an integral cylinder housing 1 having a simple cast core for the interior space can be manufactured. Also, complicated cast cores for defining radial undercuts because of the required control windows 5 in the cylinder wall 2 are unnecessary.

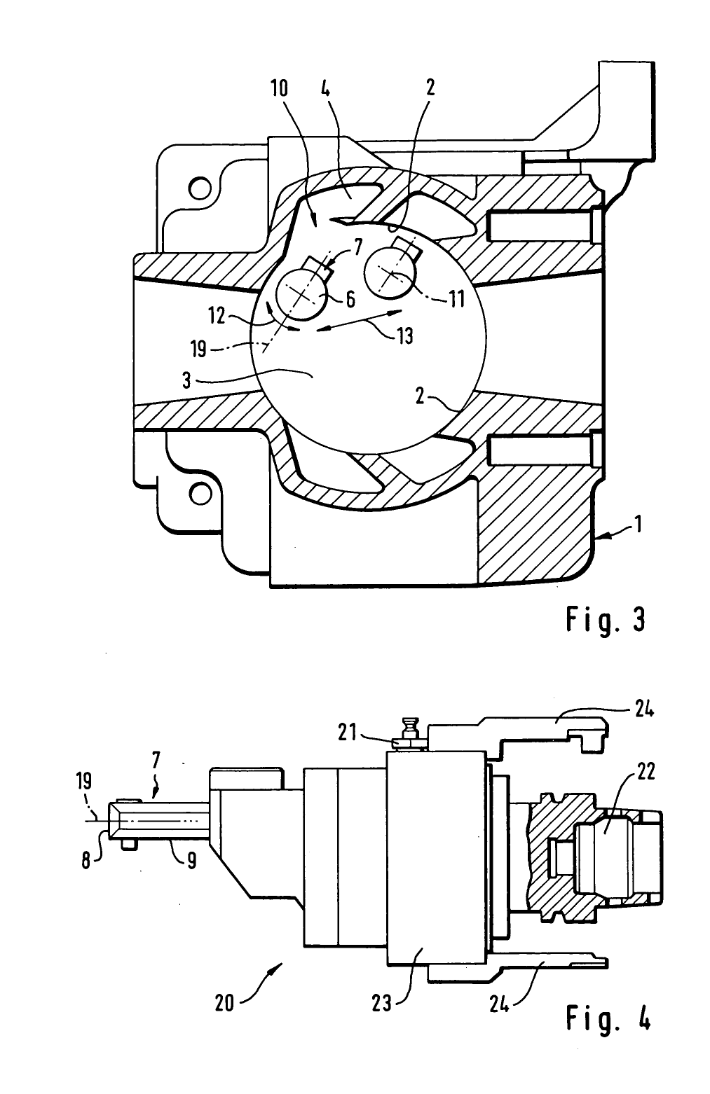

In addition to the configuration shown in FIGS. 1 and 2 having flow channels 4 connected to the outer side of the cylinder housing 1, the milling machining of the cylinder housing 1 for forming the control windows for cast cylinder housings having transfer channels enclosed integrally in the cylinder wall is advantageous in the longitudinal direction of the cylinder. The transfer channels can be produced during casting. The milling operation for forming the control windows 5 with a milling tool can be advantageous also in other areas of application in essentially radial breakthroughs in the cylinder wall 2. The milling tool is explained hereinafter with respect to FIGS. 3 to 6.

FIG. 3 shows a cross section of a cylinder housing 1 for a slot-controlled two-stroke engine. The cylinder housing 1 is manufactured as a pressure-cast part having transfer channels 4 in the longitudinal direction of the cylinder. The transfer channels 4 are enclosed in the cylinder wall and, in the embodiment shown, lie diametrically opposite each other. The transfer channels 4 are originally formed with their section, which runs longitudinally in the cylinder wall 2, as a hollow space of the cast cylinder housing 1 together with the cylindrical interior space 3 for accommodating the reciprocating piston. Since the cylinder wall 2 is originally formed without a back cut, the accesses of the transfer channels 4 to the interior space 3 of the cylinder are closed in the cast blank of the cylinder housing 1. By chip-removal processing of the cylinder wall 2 with the milling tool 7 of the invention, control windows 5 are formed in the interior space 3 as openings of the transfer channels 4. The milling tool 7 for cutting out the control window 5 is mounted on a tool holder at the free end of a drive spindle of a numerically-controlled machine tool in such a manner that the drive axis of the milling tool lies essentially orthogonally to the rotational axis of the drive spindle 6. The milling tool 7 is introduced into the interior space 3 of the cylinder housing 1 and is brought into its work position next to the cylinder wall 2 to there cut out a control window 5. The interior space 3 of the cylinder housing 1 is open at the flange 15 (FIG. 1). The milling tool can be driven by pivot movements 12 of the drive spindle into the desired angular position and is brought into engagement with the cylinder wall 2 by transverse movements 13 of the drive spindle 6 with reference to its spindle axis. A breakthrough 10 is machined into the cylinder wall 2 with the aid of the milling tool 7 and a flow connection of the transfer channel 4, which had up to now been enclosed in the cylinder wall 2, is established with the interior space 3. With controlled movements of the drive spindle with a suitable matching of transverse movements 13 and pivot movements 12 as required, the breakthrough 10 in the cylinder wall 2 is expanded to the required dimensions of the control window 5. The arrangement of the milling tool with the drive axis of the tool 7 lying orthogonally to the longitudinal axis of the drive spindle permits a precise guidance of the tool within the space of the cylinder interior which is available.

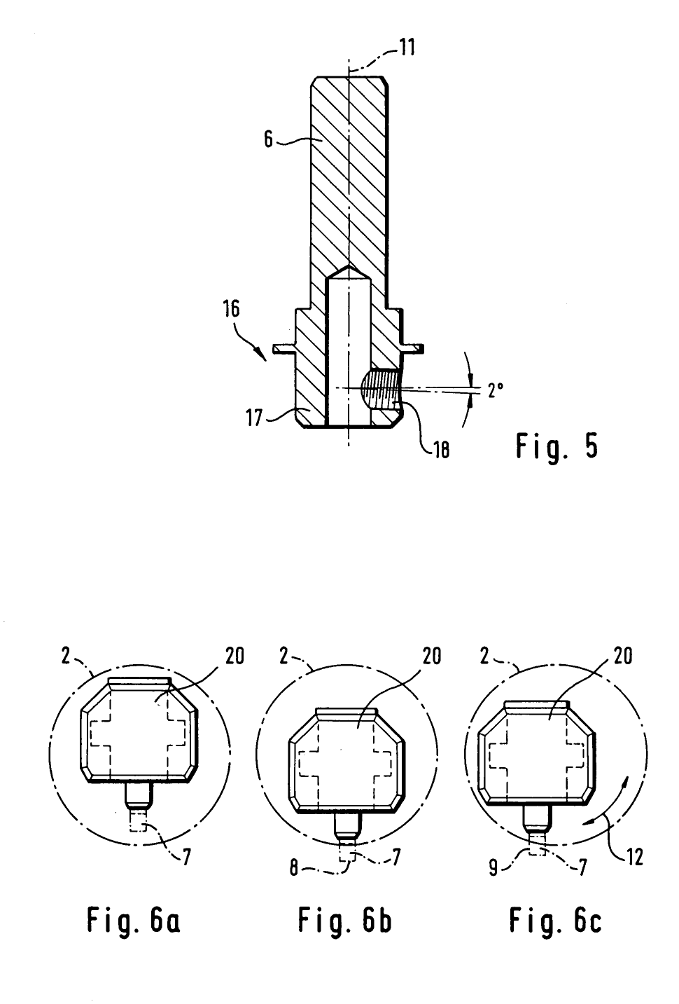

The milling tool 7 is part of a tool head 20 (FIG. 4), which can be mounted as a compact assembly on a tool holder 17 (FIG. 5) at the free end 16 of the drive spindle 6. The milling tool 7 of the tool head 20 is configured as a combination of an end-milling tool and a face-milling tool and has cutters at its end face 8 as well as on its periphery 9. The cutters at its end face 8 act perpendicularly to the drive axis 19. The milling tool 7 is configured in the manner of a dentist's tool and can be plunged into the cylinder wall with the action of the end-milling cutter and, thereafter, can machine out the contour of the control window with the aid of the cutters at the periphery 9 of the milling tool 7.

The milling tool 7 is driven by a motor 23 about its drive axis 19. The motor 23 can be configured as a pneumatic motor, hydraulic motor or as an electric motor. The motor 23 is preferably a pneumatic motor and part of the tool head 20. The motor is connected to an energy source in a manner of a one-hand coupling. The tool head 20 is further configured with torque supports 24 and is inserted with a lug-shaped connection 22 in a receptacle 18 of the work tool holder 17 in the drive spindle 6. The receptacle 18 of the work tool holder 17 lies essentially orthogonally to the rotational axis 11 of the drive spindle 6 whereby, in the assembled state of the tool head 20, the drive axis 19 of the milling tool 7 is perpendicular to the rotational axis 11 of the spindle 6. The receptacle 18 can be so configured that the drive axis 19 of the milling tool 7 is perpendicular to the rotational axis 11 of the drive spindle 6 in both planes. Also, a small positioning angle of 2° of the receptacle 18 can be advantageous for the tool head relative to the rotational axis 11.

FIGS. 6a to 6c show three possible positions of the tool head 20 in the cylinder for machining the cylinder wall shown in phantom outline. In FIG. 6a, the plunge position of the tool head 20 into the cylinder is shown with the milling tool 7 guided thereon. The tool head 20 with the motor, which is accommodated thereon, can be precisely guided in the cylindrical interior space with the drive spindle of a numerically controlled machine tool. As shown in FIG. 6b, the milling tool 7 can be introduced deep into the cylinder wall 2. With the aid of the end face cutter 8, all radial machining of the cylinder wall 2 with reference to the cylindrical axis is possible. The milling tool 7 has cutters on its periphery 9 with which a tangential machining of the cylinder wall 2 is possible. With pivot movements of the drive spindle of the machine tool and the tool head 20 held thereon, the outer surface 9 of the milling tool 7, which is provided with cutters, can be used to precisely configure contours of the control window 5. Any desired angular alignment of the machined surfaces in the cylinder wall 2 can be made by spatially positioning the drive spindle and therefore the tool head 20 within the cylindrical interior space and coordinating pivot movements 12 therewith. The arrangement of the invention for forming control windows with a milling tool with the drive axis lying essentially orthogonally to the rotational axis of the tool holder, makes possible the precise configuration of the control windows even for small cylinders having a bore diameter of less than 80 mm via precise guidance of the tool.

With the milling tool of the invention, which lies orthogonally to the drive spindle, the configuration of the control window can take place in a one-step machining method with the same tool which introduces the breakthroughs with an end-milling cutter and expands the breakthroughs to the required dimensions and contours of the control window with a peripheral-milling cutter. A multi-step processing of the cylinder wall is also possible. The cylinder wall of the cast blank of the cylinder housing is broken through for opening the transfer channels 4 utilizing a disc-milling cutter. The comma-shaped burrs, which remain after machining with the disc cutter at the edge of the breakthrough in the cylinder wall, are further machined in a subsequent machining step with a tool head 20 with a milling tool lying orthogonally to the spindle axis. The angles of the control window walls can be machined thereafter as described above.

It is understood that the foregoing description is that of the preferred embodiments of the invention and that various changes and modifications may be made thereto without departing from the spirit and scope of the invention as defined in the appended claims.

What is claimed is:

1. An arrangement for forming a control window in a cylinder wall of a cylinder housing for a two-stroke internal combustion engine, the cylinder wall delimiting an interior space of the cylinder and the control window being an opening of a flow channel into said interior space, the arrangement comprising:
a tool holder having a free end and defining a rotational axis about which said tool holder can be rotated;
a driveable cutting tool mounted on said tool holder at said free end thereof and having a drive axis lying essentially orthogonally to said rotational axis; and,
said tool holder with said driveable tool being movable into said interior space and being movable transversely with respect to said rotational axis so as to be brought into contact engagement with said cylinder wall at the position provided for said control window which is to be cut out of said cylinder wall.

2. The arrangement of claim 1, wherein said cutting tool is configured as a face milling cutter.

3. The arrangement of claim 2, wherein said face milling tool has a peripheral cutting edge for cutting in the peripheral direction about said drive axis.

4. The arrangement of claim 1, wherein said cutting tool is driven pneumatically.

5. The arrangement of claim 1, wherein said cutting tool is driven hydraulically.

6. The arrangement of claim 1, wherein said cutting tool is driven electrically.

7. The arrangement of claim 1, wherein said cutting tool is part of a tool head connectable to said tool holder.

8. The arrangement of claim 7, wherein said tool head includes a pneumatic motor for driving said cutting tool.

9. The arrangement of claim 1, wherein said tool holder is connected to a drive spindle of a controllable machine tool so as to rotate with said drive spindle.

10. The arrangement of claim 9, wherein said tool holder is part of said drive spindle.
